(19) United States
(12) Patent Application Publication
(10) Pub. No.: US 2020/0281226 A1
(43) Pub. Date: Sep. 10, 2020

(54) LIVESTOCK FEED

(71) Applicant: Jung Bong LEE, Incheon (KR)

(72) Inventor: Jung Bong LEE, Incheon (KR)

(21) Appl. No.: 16/762,923

(22) PCT Filed: Nov. 8, 2018
(86) PCT No.: PCT/KR2018/013579

§ 371 Date: May 9, 2020

(30) Foreign Application Priority Data
Nov. 14, 2017 (KR) 10-2017-0151683

(51) Int. Cl. A23K 10/30; A23K 50/30; A23K 50/10; A23K 50/75; A23K 20/174; A23K 20/28

(52) U.S. Cl. CPC A23K 10/30; A23K 50/30; A23K 20/28; A23K 50/75; A23K 20/174; A23K 50/10

(57) ABSTRACT

The present invention relates to a livestock feed and, more particularly, to a feed supplemented with nutritional components such as vitamins to improve the health such as immunity, of livestock and improve meat quality. Accordingly, the present invention provides a livestock feed for the growth of pigs, cattle, chickens, and ducks, comprising tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, and zeolite as nutrition-enriched additives, and further comprising a soothing agent containing licorice in order to alleviate the irritation of the Salvia miltiorrhiza extract, the Platycodon extract, Angelica, and the sea buckthorn fruit extract.

### TECHNICAL FIELD

The present invention relates to a livestock feed and, more particularly, to a feed supplemented with nutritional components such as vitamins to improve the health such as immunity, of livestock and improve meat quality.

### BACKGROUND ART

With the tendency of continuously increasing the consumption of edible meat, the livestock feed for improving meat quality is attracting growing attention. In the present invention, a sea buckthorn and Acanthopanax, which are widely known as vitamin trees, are added, thereby increasing the health level of livestock and improving meat quality.

Sea buckthorn (botanical name: Hippophae rhamnoides) is spiky plant bearing bright orange fruits, is native North Asia and Europe, and is one of the original plants that have settled on the Scandinavian peninsula since the end of the ice age. The fruits of Hippophae rhamnoides have long been known to be beneficial for health, and it is also mentioned in traditional Tibetan medicine, traditional Chinese herbal medicine, and Indian Ayurvedic medicine. Nowdays, the fruits of Hippophae rhamnoides have a significantly higher content of vitamins C and E than other fruits such as mandarin and orange. Recently, studies have been underway to develop it as a raw material for compounds that reduce cholesterol levels. Hippophae rhamnoides withstand harsh cold and is covered with long thorns, and thus, in English, it is also called Alpine sandthorn, Siberian pineapple, etc. Some juices are made from the fruits of Hippophae rhamnoides, and usually mix and drink with other fruit juices. Hippophae rhamnoides are also used as a raw material for herbal medicine and skin care products.

In Korea, Acanthopanax refers to the bark of the roots, stems and branches of the ginseng family Acanthopanax sessiliflorum Seeman or the congeneric plant. In China, it refers to the root bark of the Acanthopanax gracilistylus WW Smith, and Acanthopanax senticosus (Rupr. & Maxin) Harms is described separately as Zhaoga. Acanthopanax supplements the energy of the liver and kidneys, and strengthens the tendons and bones, so it is used for the treatment of quadriplegia, contracture, waist and knee weakness, lower limb impotence, bone fractures, bruises, and edema. As the pharmacological action thereof, immune enhancement, anti-oxidation, anti-fatigue, anti-high temperature, anti-irritation action, endocrine function regulation, blood pressure regulation, anti-radiation, detoxification effects have been reported.

As a feed for improving the growth of livestock and improving meat quality, Korean Patent Registration No. 10-1420974 discloses feed additives for livestock comprising, as active ingredients, 10 to 40 wt % of Portulaca oleracea, 10 to 50 wt % of alum, 3 to 10 wt % of ginger, and 3 to 10 wt % of cinnamon, additionally comprises one or more excipients selected from rice bran, soybean cake, and wheat shorts if necessary, and further comprises jasmine and aloe in order to neutralize the smell of the active components as necessary. The above feed additives can prevent side effects from conventional chemical antibiotics and can be used as feed additives to replace the chemical antibiotics by obtaining a comparable effect at a raising rate (survival rate), average weight (gain rate), and a feed conversion rate, compared with the chemical antibiotics.

Korean Patent Registration No. 10-1406863 discloses an abalone-mixed complex functional feed additives containing a Broussonetia kazinoki extract and a Cudrania tricuspidata extract, and an abalone-mixed feed containing the same, in which the Broussonetia kazinoki extract and the Cudrania tricuspidata extract are mixed in a conventional mixed feed as a natural feed with complex physical properties capable of performing the function as an anti-oxidant and clay shape retention agent derived from natural products, and are used as feed additives during abalone breeding, whereby it suppresses the rancidity, increases immunity by excellent tolerance against various types of stresses, delays the speed of precipitation of feed, increases the digestion capability by not causing the resistance of fish, increases the shape retention of feed in water, the intake rate of feed and feed use efficiency, does not cause water pollution and makes an environment-friendly farming possible by reducing the water pollution.

However, the complex functional feed additives of Korean Patent Registration No. 10-1406863 are not suitable as a livestock feed, and thus, a feed with a more balanced nutrition was needed. In this regard, the present applicant has filed a patent application entitled “livestock feed” which was published under Korean Unexamined Patent Publication No. 10-2017-0011525. The Patent Publication No. 10-2017-0011525 relates to a livestock feed, particularly to a feed supplemented with nutrient components such as vitamins to improve health, such as immunity of livestock, and improve meat quality. The Patent Publication No. 10-2017-0011525 provides a feedstock feed for the growth of pigs, cows, poultry, ducks, comprising tocopherols, germanium minerals, Acanthopanax plant extract, and sea buckthorn (botanical name: Hippophae rhamnoides) fruit extract as additives.

### PRIOR ART DOCUMENT

### Patent Document

(Patent Document 1) Korean Patent Registration No. 10-1420974 entitled “Feed additive for livestock”, published on Jul. 17, 2014

(Patent Document 2) Korean Patent Registration No. 10-1406863 entitled “Abalone mixed complex functional feed additives containing a Broussonetia kazinoki extract and a Cudrania tricuspidata extract, and abalone mixed feed containing the same”, published on Jun. 13, 2014

(Patent Document 3) Korean Unexamined Patent Publication No. 10-2017-0011525 entitled ‘Livestock feed’ and published on Feb. 2, 2017

### DETAILED DESCRIPTION OF THE INVENTION

### Problems to be Solved

The present invention is intended to improve a “livestock feed” of Korean Unexamined Patent Publication No. 10-2017-0011525 in the name of the applicant, and an object thereof is to provide a feed which alleviates irritation properties such as zeolite, sulfur, vitamin trees, Salvia miltiorrhiza, Angelica, medicinal bellflower, in particular, supplemented with nutritional components such as vitamins to improve the health such as immunity, of livestock and improve meat quality.

### Solutions to Solve the Problems

In order to achieve the above object, there is provided a livestock feed for the growth of pigs, cattle, chickens, and ducks, comprising, as additives, tocopherol, germanium mineral, Acanthopanax plant extract, and sea buckthorn (botanical name: Hippophae rhamnoides) fruit extract widely known as vitamin trees,

### Advantages of Invention

Advantageous effects can be expected from the components added to the feed of the present invention, such as growth promotion by tocopherol, lactation promotion by germanium, somatic cell reduction by germanium minerals, mastitis preventing effect by Acanthopanax, and immunity-enhancing effect by sea buckthorn fruit. In particular, vitamins rich in sea buckthorn fruit, widely known as vitamin trees, can significantly improve the growth of livestock.

Among the components included in the feed of the present invention, Salvia miltiorrhiza extract, Platycodon extract, Angelica, and sea buckthorn fruit extract have high irritation property, and thus, even if a small amount is applied, they may have adverse effects on some livestock. Thus, in the present invention, licorice was applied as a soothing agent to alleviate their irritation property.

In other words, although the livestock feed of the present invention has a high health promotion effect, but it is applied by relieving the irritation of components with strong irritation, whereby the effects of improving the immunity of livestock, preventing diseases, improving health conditions, promoting the growth and improving meat quality can be expected.

### Embodiments

Hereinafter, the present invention will be described in detail. However, the present invention may be realized in various different forms, and it is not limited to the embodiments set forth herein.

Further, throughout the specification, when a part is referred to as “including” a certain component, it does not mean that other constructional elements are excluded, but it means that other constructional elements can be further included, unless described to the contrary.

Further, the terminology used herein is for the purpose of describing exemplary embodiments only and it is not intended to restrict the present invention. The singular forms are intended to include the plural forms as well, unless the context clearly indicates otherwise. The term “include”, “comprise”, or “have” is intended to specify the presence of stated features, integers, steps, operation, components, elements, or combinations thereof, but does not preclude the presence or addition of one or more other features, integers, steps, operation, components, elements, or combinations thereof.

Embodiments of the present invention will be described in detail below.

The present invention relates to a livestock feed and, particularly, to a feed supplemented with nutritional components such as vitamins to improve the health such as immunity, of livestock and improve meat quality. Thus, the present invention provides a livestock feed for the growth of pigs, cattle, chickens, and ducks, comprising tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, and zeolite as nutrition-enriched additives, and further comprising a soothing agent containing licorice in order to alleviate the irritation of the Salvia miltiorrhiza extract, the Platycodon extract, Angelica, and the sea buckthorn fruit extract. That is, the feed of the present invention is produced by adding the nutrition-enriched additives and the soothing agent in a feed mainly composed of cereals, gourds, and cereal by-products.

The Acanthopanax plant extract and the sea buckthorn fruit extract can be powdered or can be directly applied as the extract, and processing such as fermentation may be applied as necessary.

The sea buckthorn fruit extract may be obtained by extracting a vitamin tree fruit using water, a C1 to C4 lower alcohol or a mixed solvent thereof, preferably, it may be extracted in 65-75% ethanol at room temperature for 3 to 6 days, more preferably, it may be extracted in 70% ethanol at room temperature for 4 to 5 days.

Further, in addition to the sea buckthorn fruit, it can be applied by processing the leaf or stem of the sea buckthorn into a size of 50 to 150 mesh.

Further, when applied by fermenting the leaf or stem of the sea buckthorn, it is preferable to ferment at a temperature higher than room temperature (40 to 50° C.) for 4 to 8 days.

The Salvia miltiorrhiza refers to a medicinal material made from the roots of Salvia miltiorrhiza Bunge, which helps blood circulation, removes blood stasis and relieves limb joint pain. It treats women's menstrual irregularities, menstrual pain, postpartum abdominal pain, postpartum abdominal pain, and bruises. It is also known to treat mental confusion caused by high fever, bullshit, dysphoria, insomnia, skin rash, and palpitations.

As the pharmacological action, expansion of coronary arteries, reduction of cholesterol, reduction of blood pressure, activation of liver function, sedative anti-inflammatory, anti-cancer, and anti-bacterial effects have been known.

Among the additives, Salvia miltiorrhiza, Angelica, Platycodon and sea buckthorn greatly contribute to the growth of livestock, but the toxicity may be harmful to livestock. Therefore, the present invention seeks to control the toxicity of the above components by adding licorice. Licorice serves to harmonize the toxicity of all medicines, exhibit a good therapeutic effect, control the heat and morale of entrails, make all blood vessels communicate well, and strengthen muscles and bones. The pharmacological action of licorice is effective in detoxification, hepatitis, hives, dermatitis, eczema, etc. It is known to have antitussive, expectoration, muscle relaxation, diuretic effect and anti-inflammatory effect, and to suppress peptic ulcer. That is, in the present invention, the content of the Salvia miltiorrhiza, Angelica, Platycodon and sea buckthorn can be increased by adding licorice.

The Acanthopanax refers to the bark of the roots, stems and branches of the ginseng family Acanthopanax sessiliflorum Seeman or the congeneric plant. The Acanthopanax supplements the energy of the liver and kidneys, and strengthens the tendons and bones, so it is used for the treatment of quadriplegia, contracture, waist and knee weakness, lower limb impotence, bone fractures, bruises, and edema. As the pharmacological action thereof, immune enhancement, anti-oxidation, anti-fatigue, anti-high temperature, anti-irritation action, endocrine function regulation, blood pressure regulation, anti-radiation, detoxification effects have been reported.

Furthermore, when zeolite and a trace amount of sulfur are powdered and mixed with a feed to give to a livestock, the effect of absorbing and excreting toxins and bacteria in the intestine of the livestock can be expected.

For the above effects, it is preferable to adsorb sulfur onto the zeolite. That is, the zeolite and sulfur of the present invention are produced through the following steps:

crushing zeolite (s100);
mixing zeolite and sulfur (s200); and
aging sulfur-adsorbed zeolite for 24 to 48 hours and drying at room temperature (s300).

It is known that the sulfur is useful for the health of joints and cartilage, and has anti-inflammatory and blood-purifying effects, but has toxicity. Thus, if a large amount of sulfur enters the body of a livestock, it is rather harmful to the health of livestock. Accordingly, the present inventor has paid attention to the introduction of sulfur in the form of adsorbing sulfur. Thereby, it is possible to add an amount greater than the allowable amount when sulfur is directly added, and it is possible to expect that bacteria, etc. of livestock adsorbed on zeolite can be sterilized with sulfur and discharged.

It is preferable to add 0.8 w % of vitamin trees, 10 w % of Salvia miltiorrhiza extract, 0.8 wt % of Angelica, 0.5 wt % of Platycodon extract, and 1 to 3 wt % of licorice based on the total weight of the prepared livestock feed.

Hereinafter, examples of the present invention will be described for each livestock applied.

### Example 1

Example 1 is a complex feed for Korean native cattle, hog raising, chicken raising, and ducks. The livestock feed in Example of the present invention contains tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, zeolite and licorice as nutrition-enriched additives, and additionally contains cereals, gourds, cereal by-products, calcium phosphate, lime, methionine, lysine, salt, choline ruminant stabilizer, vitamin premix and mineral premix, wherein as a weight ratio, it is a feed on pellets containing 17 to 25% of crude protein, 3 to 10% of crude fat, 2 to 18% of crude fiber, 12 to 20% of crude ash, 0.5 to 5% of calcium, and 0.1 to 1.3% of phosphorus. The feed of Example 1 prepared by the present inventor is as shown in Table 1 below.

TABLE 1

| Component name | Amount of component |
|---|---|
| Crude protein | 17.0% or more |
| Crude fat | 3.0% or less |
| Crude fiber | 18.0% or less |
| Crude ash | 12.0% or less |
| Calcium | 0.50% or more |
| Phosphorus | 1.30% or less |
| Total digestible nutrients (TDN) | 72.0% or more |

The feed of Example 1 is aimed at a livestock from after childbirth to three months before lactation. Among the components added to the feed of the present example, the lactation promoting effect of tocopherol, the reduction of somatic cells due to germanium, the effect of preventing mastitis due to Acanthopanax, and the effect of enhancing the immunity due to the fruit of the sea buckthorn (vitamin tree) can be expected.

### Example 2

Example 2 is directed to a feed for a livestock (Korean native cattle, beef cattle, dairy cattle). The livestock feed of the present example contains tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, zeolite and licorice as nutrition-enriched additives, and additionally contains cereals, cereal by-products, gourds, molasses, limestone, calcium phosphate, salt, vitamin premix and mineral premix, wherein as a weight ratio, it is a feed in the form of flake containing 13 to 25% of crude protein, 2.5 to 10% of crude fat, 2 to 10% of crude fiber, 2 to 10% of crude ash, 0.7 to 5% of calcium, and 0.1 to 1.2% of phosphorus. The feed of Example 2 prepared by the present inventor is as shown in Table 2 below.

TABLE 2

| Component name | Amount of component |
|---|---|
| Crude protein | 13.0% or more |
| Crude fat | 2.50% or less |
| Crude fiber | 10.0% or less |
| Crude ash | 10.0% or less |
| Calcium | 0.70% or more |
| Phosphorus | 1.0% or less |
| Total digestible nutrients (TDN) | 12.0% or less |

The feed of Example 2 is aimed at a cattle with a body weight of 250 to 400 kg, and in the same manner as in Example 1, the improvement effect due to tocopherol, germanium, Acanthopanax and sea buckthorn fruit can be expected.

### Example 3

Example 3 is a feed for hog-raising, wherein the livestock feed contains tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, zeolite and licorice as nutrition-enriched additives, and additionally contains whey powder, milk fat, processed oil, soy protein, processed cornmeal, minerals and vitamins. wherein as a weight ratio, it is a feed in the form of powder containing 20 to 30% of crude protein, 5 to 15% of crude fat, 5 to 15% of crude fiber, 2 to 10% of crude ash, 0.6 to 5% of calcium, 0.1 to 1.5% of phosphorus and 1.65 to 5% of lysine. The feed of Example 3 prepared by the present inventor is as shown in Table 3 below.

TABLE 3

| Component name | Amount of component |
|---|---|
| Crude protein | 20.5% or more |
| Crude fat | 5.0% or more |
| Crude fiber | 5.0% or more |
| Crude ash | 10.0% or less |
| Calcium | 0.6% or more |
| Phosphorus | 1.5% or less |
| Lysine | 1.65% or more |
| Digestible crude protein (DCP) | 18.0% or more |
| Digestible energy (DE) | 3.700 kcal or more |

The feed of Example 3 are mainly aimed at suckling pigs, and in the same manner as in Example 1, the improvement effect due to tocopherol, germanium, Acanthopanax, and sea buckthorn fruit can be expected.

Although the present invention has been described together with examples, these are only one of various embodiments including the gist of the present invention, and the purpose is to enable those skilled in the art to easily carry out. It will be apparent that the present invention is not limited to the above-described embodiment. Therefore, the protection scope of the present invention should be interpreted by the appended claims below, and any technical idea within the scope equivalent thereto due to changes, substitutions, substitutions and the like without departing from the scope of the present invention will be included in the scope of rights of the present invention.

What is claimed is:

1. A livestock feed for the growth of pigs, cattle, chickens, and ducks, comprising:
tocopherol, germanium mineral, Acanthopanax plant extract, sea buckthorn (botanical name: Hippophae rhamnoides) fruit extract, sulfur, Hovenia dulcis peduncle extract, Angelica, Salvia miltiorrhiza extract, Platycodon extract, Prunus armeniaca, and zeolite as nutrition-enriched additives, and further comprising a soothing agent containing licorice in order to alleviate the irritation in the body of the Salvia milliorrhiza extract, the Platycodon extract, Angelica, and the sea buckthorn fruit extract,
wherein the zeolite is produced through the following steps:
crushing zeolite (s100);
mixing zeolite and sulfur (s200); and
aging sulfur-adsorbed zeolite for 24 to 48 hours and drying at room temperature (s300),
wherein it is added by impregnating sulfur in advance.
